(19) United States
(12) Patent Application Publication
(10) Pub. No.: US 2015/0135949 A1
(43) Pub. Date: May 21, 2015

(54) WET ELECTROSTATIC PRECIPITATOR AND FLUE GAS TREATMENT METHOD

(71) Applicant: MITSUBISHI HEAVEY INDUSTRIES MECHATRONICS SYSTEMS, LTD., Kobe-shi, Hyogo (JP)

(72) Inventors: Kenji Matsuura, Hyogo (JP); Shiro Suzuki, Hyogo (JP); Tooru Nishiyama, Hyogo (JP); Mitsuaki Nishitani, Hyogo (JP); Yasutoshi Ueda, Tokyo (JP)

(73) Assignee: MITSUBISHI HEAVEY INDUSTRIES MECHATRONICS SYSTEMS, LTD., Kobe-shi, Hyogo (JP)

(21) Appl. No.: 14/403,808

(22) PCT Filed: May 17, 2013
(86) PCT No.: PCT/JP2013/063769

§ 371 Date: Nov. 25, 2014

(30) Foreign Application Priority Data
Jun. 29, 2012 (JP) 2012-147421

(51) Int. Cl. B03C 3/16; B03C 3/47

(52) U.S. Cl. CPC B03C 3/16; B03C 3/47
USPC 95/80; 96/54

(57) ABSTRACT

A wet electrostatic precipitator includes an electric field forming unit including a first electrode and a second electrode which form an alternating electric field. The first electrode is a flat plate, and has a plurality of discharge electrodes on a surface that opposes the second electrode. The second electrode includes a discharge frame, a first flat plate portion and a second flat plate portion. The first flat plate portion opposes the discharge electrode of the first electrode. A plurality of discharge electrodes are formed on a surface of the second flat plate portion that opposes the first electrode. The discharge electrodes alternately generate corona discharges having opposite polarities in a direction perpendicular to a flow direction of gas, and alternately apply charges having opposite polarities to mist and dust. The first electrode and the first flat plate portion trap the charged mist and the dust.

### TECHNICAL FIELD

The present invention relates to a wet electrostatic precipitator which removes mist containing SOₓ or dust of gas and a flue gas treatment method.

### BACKGROUND ART

Flue gas containing dust (particulate matter) is discharged from a coal-fired or heavy oil-fired power plant, an industrial combustion facility such as an incinerator, and the like. In the combustion flue gas, SOₓ gas such as SO₂ or SO₃ is contained. In order to remove dust and SOₓ, a flue gas treatment system is provided in the flue on the downstream side of the combustion facility. In the flue gas treatment system, for example, as in PTL 1, a denitrification device, an air heater, a dust collection device, a wet desulfurization device, and a wet electric dust collector are provided from the upstream side in this order. After the flue gas is cooled in the wet desulfurization device in the flow passage of the flue gas treatment system, SO₃ is present in a mist state.

The SO₃ mist is about 0.1 μm in size and is thus fine. However, after passing through the wet desulfurization device, the SO₃ mist absorbs moisture and becomes large. When the large mist or dust flows into the wet electric dust collector, the surface area thereof is larger than that before the enlargement, and thus the charge amount of the mist is increased and a space charge effect is increased, resulting in a significant reduction in the discharge current of the wet electric dust collector. Since there is a strong correlation between the SO₃ mist and dust removal performance and the discharge current, when the current is reduced, the SO₃ mist and dust removal performance is also degraded.

In PTLs 1 and 2, before the gas flows into a dust collection unit of the wet electric dust collector, the SO₃ mist or the dust is pre-charged. In addition, a method is employed in which droplets having a larger particle size than the mist are sprayed into the gas and a discharge technique of alternately generating positive and negative corona discharges in order to increase the probability of collision between the SO₃ mist or the dust is combined therewith. The charged SO₃ mist or dust is attracted to the droplets that are dielectrically polarized by an electric field of the dust collection unit due to the Coulomb force or gradient force, and is thus absorbed in the droplets. Since the droplets have large particle sizes, the droplets are easily trapped by a simple trapping device which uses collision or inertia, such as a demister provided on the downstream side of the wet electric dust collector.

### CITATION LIST

### Patent Literature

[PTL 1] Japanese Unexamined Patent Application Publication No. 2010-69463

[PTL 2] Japanese Patent No. 3564366

### SUMMARY OF INVENTION

### Technical Problem

In the wet electric dust collector of PTLs 1 and 2, in order to remove SO₃ with high efficiency, the device which pre-charges the SO₃ mist, the device which sprays droplets, the demister which collects the droplets, and the like are essential components.

Contrary to this, an object of the present invention is to provide a wet electrostatic precipitator which increases SO₃ and dust removal performance with a simpler device, and a flue gas treatment method.

### Solution to Problem

According to an aspect of the present invention, a wet electrostatic precipitator for removing SO₃ and dust contained in gas, includes: an electric field forming unit which includes a first electrode and a second electrode that are arranged to oppose each other along a flow direction of the gas containing mist having the SO₃ incorporated therein and the dust so as to form a direct current electric field, wherein the first electrode is a flat plate and includes a plurality of discharge electrodes formed on a surface of the first electrode that opposes the second electrode, along the flow direction of the gas at predetermined intervals, the second electrode includes a discharge frame, a first flat plate portion which extends in a direction substantially perpendicular to the flow direction of the gas and is provided at a position that opposes the discharge electrode of the first electrode, and a second flat plate portion which extends in the direction substantially perpendicular to the flow direction of the gas and has a plurality of discharge electrodes formed on a surface that opposes a flat surface part of the first electrode, the first flat plate portion and the second flat plate portion are arranged along the flow direction of the gas, the discharge electrode of the first electrode and the discharge electrode of the second electrode alternately generate corona discharges having opposite polarities in the direction perpendicular to the flow direction of the gas so as to apply charges having opposite polarities to the mist and the dust by the corona discharges when the gas passes through between the first electrode and the second electrode, and the first electrode and the first flat plate portion trap the charged mist and the dust.

Since the electric field forming unit in the wet electrostatic precipitator according to the aspect of the present invention alternately generates the corona discharges having opposite polarities in the first electrode and the second electrode, a space charge relaxation effect can be enhanced.

The second electrode is configured so that a plurality of flat plate portions are arranged in the discharge frame in the gas flow direction. The first flat plate portion is provided to ensure discharge current of the corona discharge by the discharge electrode of the first electrode. A plurality of discharge electrodes are provided in the second flat plate portion. By implementing the electrodes in this configuration, the electrode area in the vicinity of the discharge electrode of the second electrode can be reduced, and thus the current of the corona discharge from the second electrode can be increased. As a result, input power can be increased without a reduction in the electrode area needed for dust collection, and thus high dust collection performance can be obtained. In the wet electrostatic precipitator according to the aspect of the present invention, since the mist or the dust is trapped by the electrode, there is no need to provide a mist trapping device such as a demister in the rear stage of the wet electrostatic precipitator.

In addition, in the wet electrostatic precipitator according to the aspect of the present invention, the electrode structure is simplified by forming the second electrode in the frame shape. According to the present invention, the weight of the electrode is significantly reduced, and thus processing for forming the discharge electrode is facilitated. As a result, a reduction in cost can be achieved.

In the present invention, in the second electrode, the first flat plate portion and the second flat plate portion may be alternately arranged in the flow direction of the gas.

In this configuration, the space charge relaxation effect is enhanced, thereby providing a wet electrostatic precipitator having high trapping performance.

In the present invention, on an upstream side of the gas, the discharge electrodes may be formed in the first electrode, the first flat plate portion and the second flat plate portion may be alternately arranged in the second electrode, the discharge electrodes of the first electrode and the discharge electrodes of the second electrode may alternately generate the corona discharges having opposite polarities in the direction perpendicular to the flow direction of the gas, and on a downstream side of the gas, the first electrode may have a flat surface shape, the second flat plate portion may be arranged in the second electrode, and the discharge electrodes of the second electrode may generate a negative corona discharge in the direction perpendicular to the flow direction of the gas.

Particularly, in a case where the concentration of SO₃ in the gas is low, when the corona discharges having opposite polarities are generated only on the gas upstream side of the electric field forming unit, space charge can be sufficiently relaxed. The first electrode does not necessarily have discharge electrodes formed on the gas downstream side, and thus processing cost can be reduced.

According to another aspect of the present invention, a flue gas treatment method of removing SO₃ and dust contained in gas by using the above-described wet electrostatic precipitator, includes the processes of: forming a direct current electric field between the first electrode and the second electrode; alternately generating the corona discharges having opposite polarities in the first electrode and the second electrode in the direct current electric field; allowing the gas to pass through between the first electrode and the second electrode where the direct current electric field is formed and the corona discharges are generated, and alternately applying the corona discharges having opposite polarities to the mist and the dust; and allowing the first electrode and the first flat plate portion to trap the charged mist and the dust.

When the above-described wet electrostatic precipitator is used, the space charge relaxation effect can be increased, the discharge current can be increased, and the flue gas can be treated with high dust collection efficiency.

### Advantageous Effects of Invention

The wet electrostatic precipitator of the present invention can obtain a high space charge relaxation effect. Therefore, a wet electrostatic precipitator having high dust collection performance can be provided.

In addition, since the electrode structure is simplified, the weight of the electrode can be reduced, and manufacture is facilitated, resulting in a reduction in manufacturing cost.

### BRIEF DESCRIPTION OF DRAWINGS

FIG. 1 is a block diagram of an example of a flue gas treatment apparatus.

FIG. 2 is a schematic view of a wet electrostatic precipitator.

FIG. 3 is an enlarged schematic view of an electric field forming unit of the wet electrostatic precipitator according to a first embodiment.

FIG. 4 is a schematic view illustrating a state of generating a corona discharge by a discharge electrode of an application electrode.

FIG. 5 is an enlarged schematic view of an electric field forming unit of a wet electrostatic precipitator according to a second embodiment.

### DESCRIPTION OF EMBODIMENTS

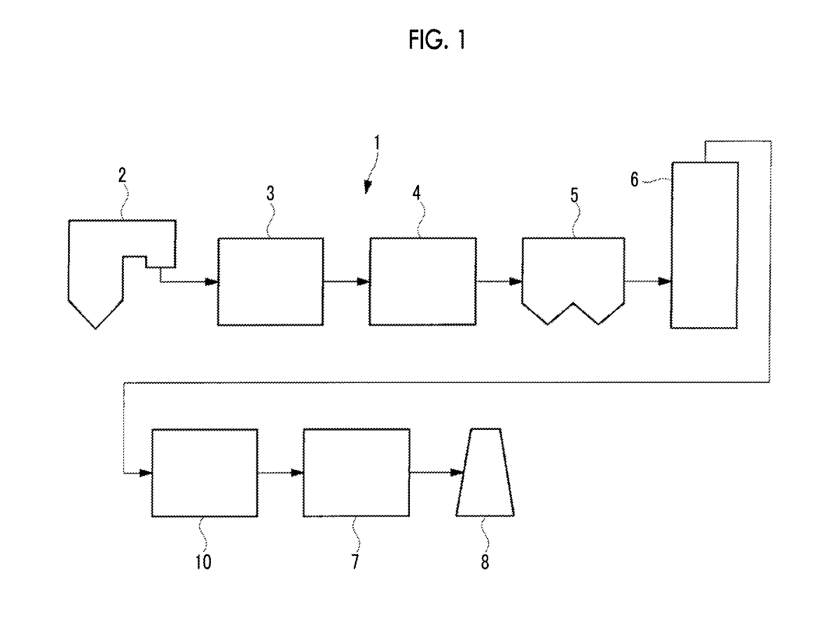

FIG. 1 is a block diagram of an example of a flue gas treatment apparatus. A flue gas treatment apparatus 1 is provided in the flue on the downstream side of a boiler (combustion furnace) 2. The flue gas treatment apparatus 1 includes a denitrification device 3, an air heater 4, a dry electrostatic precipitator 5, a wet desulfurization device 6, a wet electrostatic precipitator 10, a CO₂ recovery device 7, and a stack 8.

The boiler 2 is a boiler which burns a fuel such as coal.

The denitrification device 3 removes nitrogen oxides (NOₓ) contained in combustion flue gas that flows from the boiler 2.

The air heater 4 allows heat exchange between the combustion flue gas and combustion air required by a draft fan (not illustrated). Accordingly, the combustion air is heated by sensible heat of the combustion flue gas and is supplied to the boiler 2.

The dry electrostatic precipitator 5 collects soot and dust in the combustion flue gas by an electrostatic force.

The wet desulfurization device 6 sprays an aqueous solution containing an absorbent into the combustion flue gas to cause the absorbent and SOₓ in the flue gas to react to each other, thereby removing SO₂ and parts of SO₃ from the flue gas. The wet desulfurization device 6 employs a gypsum-limestone method, a sodium method, or a water magnesite method. The absorbent is CaO (limestone) in the case of the gypsum-limestone method, NaOH in the case of the sodium method, and Mg(OH)₂ in the case of the water magnesite method. A plurality of wet desulfurization devices 6 may be provided in series in the flow passage of the flue gas.

A desulfurization cooling tower is provided in the inlet portion in the wet desulfurization device 6. The flue gas is rapidly cooled when passing through the desulfurization cooling tower, and flue gas at about 60° C. is discharged from the wet desulfurization device 6.

The wet electrostatic precipitator 10 removes soot and dust or SOₓ that have not been trapped by the dry electrostatic precipitator 5 and the wet desulfurization device 6, by an electrostatic force.

The CO₂ recovery device 7 removes carbon dioxide contained in the flue gas. The cleaned gas is discharged to the atmosphere through the stack 8.

### First Embodiment

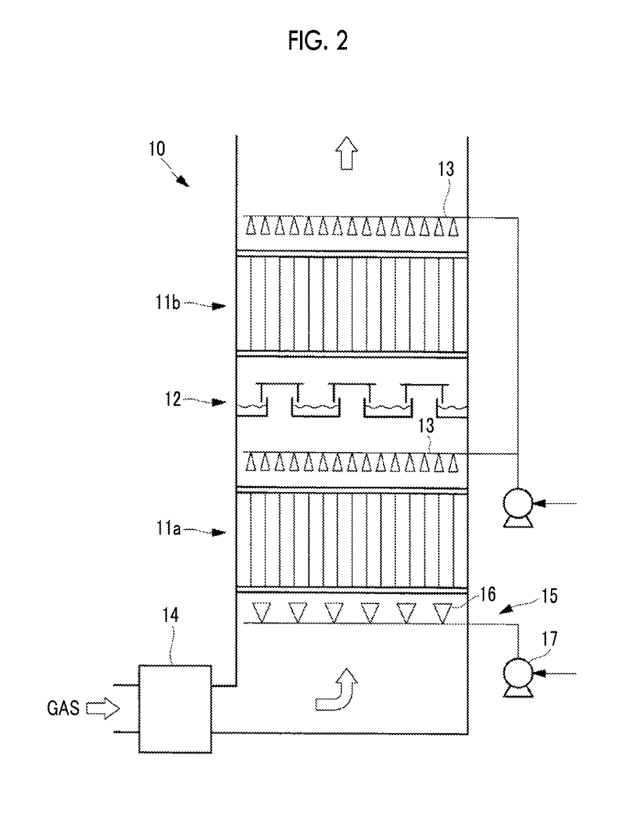

FIG. 2 is a schematic view of the wet electrostatic precipitator according to a first embodiment. The wet electrostatic precipitator 10 includes two electric field forming units 11a and 11b which are arranged in series in the flow direction of the gas. The flue gas flows from the lower side of the wet electrostatic precipitator 10, passes through the electric field forming units 11a and 11b, and is discharged from the upper side. In addition, although the two electric field forming units are provided in FIG. 2, one or three or more electric field forming units may be provided depending on the required performance of the wet electrostatic precipitator 10.

As illustrated in FIG. 2, a cleaning spray 13 may be provided above each of the electric field forming units 11a and 11b. The cleaning spray 13 is connected to a tank (not illustrated) so that cleaning water is sprayed from the cleaning spray 13 onto the electric field forming unit 11.

A chimney tray 12 which recovers the cleaning water is provided on the upper side of the electric field forming unit 11a.

In FIG. 2, the configuration in which the flue gas flows to ascend from the lower side the wet electrostatic precipitator 10 is employed. However, a configuration in which the flue gas descends from the upper side of the wet electrostatic precipitator may be employed, or a configuration in which the electric field forming units are arranged to cause the flue gas to flow in the horizontal direction may be employed.

In the wet electrostatic precipitator 10 according to this embodiment, a pre-charging unit 14 which charges SO₃ mist and dust may be provided on the upstream side of the electric field forming unit 11. The pre-charging unit 14 includes an electrode part therein. The electrode part has a structure which includes, for example, a plurality of protruding discharge electrodes supported by a support structure and a flat plate-shaped grounded electrode. In this case, the tip end of the discharge electrode and the grounded electrode are arranged to oppose each other, and the support structure and the grounded electrode are arranged to be substantially parallel to each other. A high-voltage power supply is connected to the support structure so that the discharge electrode generates a corona discharge. The gas flows between the support structure and the grounded electrode, and the SO₃ mist and the dust in the flue gas are negatively charged by the corona discharge.

A dielectric spray unit 15 which sprays a dielectric (water) into the flue gas in a mist form may be provided on the upstream side of the electric field forming unit 11 and on the downstream side of the pre-charging unit 14. The dielectric spray unit 15 includes a single or a plurality of nozzles 16 and a pump 17 which supplies the dielectric to the nozzles 16. A droplet of the dielectric (water) sprayed from the dielectric spray unit 15 is about 600 μm in size.

In a case where the concentration of SO₃ flowing into the wet electrostatic precipitator 10 is low, for example, by reason that coal having a small sulfur content is used as a fuel, or SO₃ is sufficiently removed by the wet desulfurization device 6, the pre-charging unit and the dielectric spray unit may be omitted.

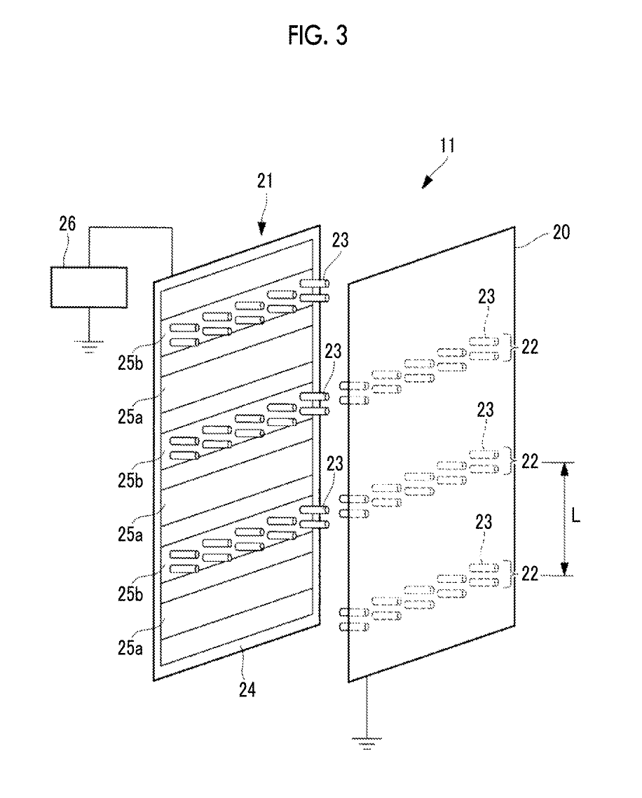

FIG. 3 is an enlarged schematic view of the electric field forming unit of the wet electrostatic precipitator according to the first embodiment.

In the electric field forming unit 11, an earth electrode (first electrode) 20 and an application electrode (second electrode) 21 are arranged to oppose each other. In FIG. 3, a group of the earth electrode 20 and the application electrode 21 is illustrated. However, a plurality of earth electrodes 20 and a plurality of application electrodes 21 may be alternately arranged. The opposing surfaces of the earth electrodes 20 and the application electrodes 21 are arranged along the flow direction of the gas.

In a case where the cleaning spray 13 is provided, spray nozzles (not illustrated) of the cleaning spray are provided above each of the earth electrode 20 and the application electrode 21.

The earth electrode 20 has a flat plate shape. A plurality of discharge units 22 are provided on the surface of the earth electrode 20 that opposes the application electrode 21 along the flow direction of the gas. The discharge units 22 are arranged to be separated at predetermined intervals. The earth electrode 20 is grounded.

The single discharge unit 22 is configured to include a plurality of discharge electrodes 23. The discharge electrode 23 provided in the earth electrode 20 has a cylindrical shape in FIG. 3, but is not limited thereto. For example, the discharge electrode 23 may have a shape with a protrusion such as a cone.

In the single discharge unit 22, the plurality of discharge electrodes 23 are arranged in a direction substantially perpendicular to the flow direction of the gas. In the single discharge unit 22, a single row or a plurality of rows (two rows in FIG. 3) of discharge electrodes 23 are provided in the flow direction of the gas. The number of rows is appropriately set in consideration of mist or dust trapping performance. Here, when the number of rows is increased, the number of discharge electrodes 23 is increased, resulting in an increase in the processing cost of the discharge unit 22. In a case where the plurality of rows of discharge electrodes 23 are formed in the single discharge unit 22, in order to suppress the interference between the discharge electrodes 23, the interval between the discharge electrodes 23 in the gas flow direction is appropriately set in consideration of the interval between the earth electrode 20 and the application electrode 21. For example, in a case where the distance between the earth electrode 20 and the application electrode 21 is 150 to 250 mm, the discharge electrodes 23 may be separated by a range of 50 to 100 mm in the flow direction of the gas.

The application electrode 21 is connected to a high-voltage power supply 26. In the application electrode 21, flat plate portions 25a (first flat plate portions) and flat plate portions 25b (second flat plate portions) are mounted in a discharge frame 24. The flat plate portions 25a and 25b extend in the direction substantially perpendicular to the flow direction of the gas. The flat plate portions 25a and 25b are alternately installed in the flow direction of the gas. The flat plate portion 25a and the flat plate portion 25b are separated from each other, and a space is provided between the flat plate portion 25a and the flat plate portion 25b.

The flat plate portion 25a has a flat plate shape, and is disposed at a position that opposes a part of the earth electrode 20 where the discharge unit 22 is formed. The flat plate portion 25a is provided to ensure discharge current in the discharge electrode 23 of the earth electrode 20. In order to ensure sufficient discharge current, in a case where the distance between the earth electrode 20 and the application electrode 21 is 150 to 250 mm, the width of the flat plate portion 25a in the gas flow direction is preferably 50 mm or greater.

The flat plate portion 25b is disposed at a position that opposes a part (flat plate part) of the earth electrode 20 where the discharge unit 22 is not provided. The flat plate portions 25b are arranged to be shifted from the discharge units 22 of the earth electrode 20 at the same interval as that between the discharge units 22 of the earth electrode 20. In FIG. 3, when the interval between the discharge units 22 of the earth electrode 20 is referred to as L, the flat plate portions 25b are arranged to be shifted from the discharge units 22 of the earth electrode 20 by a phase difference of L/2.

The flat plate portion 25b has a flat plate shape, and a plurality of discharge electrodes 23 are formed on the surface thereof that opposes the earth electrode 20. The discharge electrode 23 provided in the application electrode 21 has a cylindrical shape in FIG. 3, but is not limited thereto. For example, the discharge electrode 23 may have a shape with a protrusion such as a cone. In the flat plate portion 25b, the plurality of discharge electrodes 23 are formed in the direction substantially perpendicular to the flow direction of the gas. A single row or a plurality of rows (two rows in FIG. 3) of discharge electrodes 23 are formed in the flow direction of the gas.

In a case where the plurality of rows of discharge electrodes 23 are provided, in order to suppress the interference between the discharges of the discharge electrodes 23, the interval between the discharge electrodes 23 in the gas flow direction is appropriately set in consideration of the interval between the earth electrode 20 and the application electrode 21. For example, in a case where the distance between the earth electrode 20 and the application electrode 21 is 150 to 250 mm, the interval between the discharge electrodes 23 may be set to be 50 to 100 mm.

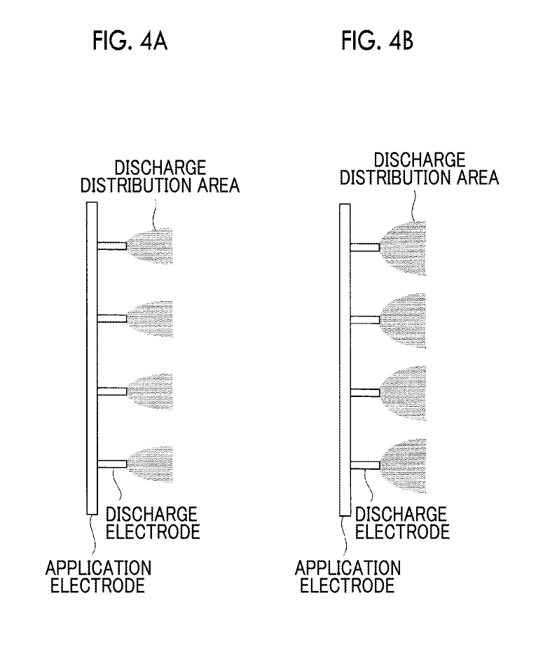

FIG. 4(a) illustrates a state of generating a corona discharge by an application electrode according to the related art, and FIG. 4(b) illustrates a state of generating a corona discharge by an application electrode according to a second embodiment. The application electrode according to the related art has the same shape as an earth electrode of the second embodiment, and a plurality of discharge units are arranged on the flat plate thereof in the flow direction of the gas.

Since the flat plate portion 25a and the flat plate portion 25b are separated from each other in the application electrode according to the first embodiment, the area of the plate (flat plate) which is present in the vicinity of the discharge electrode 23 is small. Therefore, in the application electrode according to the second embodiment, compared to the application electrode in the related art, as the interference due to the potential of the flat plate portion is relaxed, the distribution area of the corona discharge widens. As the distribution area of the corona discharge widens, an increase in current can be achieved.

A method of removing SO₃ and dust in the gas by using the wet electrostatic precipitator including the electric field forming unit 11 according to the first embodiment will be described with reference to FIGS. 2 and 3.

In the electric field forming units 11a and 11b, a negative voltage is applied to the application electrode 21 from the high-voltage power supply 26. Therefore, a direct current electric field is formed between the earth electrode 20 and the application electrode 21.

A positive corona discharge is generated by the discharge electrode 23 of the earth electrode 20. A negative corona discharge is generated by the discharge electrode 23 of the application electrode 21.

The flue gas which passes through the denitrification device 3 to the wet desulfurization device 6 of the flue gas treatment apparatus 1 flows into the wet electrostatic precipitator 10 from the lower side thereof. In the flue gas, SO₃ and dust which have not been removed by the dry electrostatic precipitator 5 and the wet desulfurization device 6 are contained.

The flue gas is rapidly cooled to about 60° C. by the desulfurization cooling tower of the wet desulfurization device 6. Since the acid dew point of SO₃ is 120 to 150° C., SO₃ gas undergoes vapor deposition in a process of becoming a moisture saturated gas at about 60° C., and is thus present as mist having SO₃ incorporated therein. The particle size of the SO₃ mist becomes smaller as the temperature difference between the inlet and the outlet of the desulfurization cooling tower increases, and the average particle size thereof is about 0.1 μm.

In a case where the pre-charging unit is not provided, the SO₃ mist and the dust in the inlet of the electric field forming unit 11 are in a state of not being charged. In addition, in a case where the dielectric spray unit is not provided, mist of the dielectric sprayed from the outside of the system is not contained in flue gas immediately before the electric field forming unit 11a.

The gas containing the SO₃ mist and the dust flows into the electric field forming units 11a and 11b where the direct current electric field and the corona discharge are generated. In the electric field forming units 11a and 11b, the SO₃ mist and the dust are charged by the corona discharge. Since the corona discharges having opposite polarities are generated in the discharge electrode 23 of the earth electrode 20 and the discharge electrode 23 of the application electrode 21, the charge polarity of the SO₃ mist and the dust alternately changes while passing through between the earth electrode 20 and the application electrode 21.

Since the SO₃ mist and the dust are influenced by the direct current electric field while alternately changing their charge polarity, the SO₃ mist and the dust travel while meandering to approach a region of the earth electrode 20 where the discharge unit is not formed or to the flat plate portion 25a of the application electrode 21. The SO₃ mist or the dust mainly approaches the earth electrode 20 and adheres to the earth electrode 20 to be trapped. The SO₃ mist or the dust which is positioned in the vicinity of the flat plate portion 25a adheres to the flat plate portion 25a to be trapped.

In a case where the pre-charging unit is provided on the upstream side of the electric field forming unit 11a, the gas containing the SO₃ mist and the dust flows into the pre-charging unit. The pre-charging unit causes the discharge electrode of the electrode portion therein to generate a corona discharge. While the gas passes through between the discharge electrode and the grounded electrode of the pre-charging unit, the SO₃ mist and the dust are negatively charged by the corona discharge.

In a case where the dielectric spray unit is provided on the upstream side of the electric field forming unit 11a, the dielectric spray unit supplies the dielectric (water) to the nozzle by the pump to spray the water mist from the nozzle into the gas. The particle size of the sprayed water mist is about tens to hundreds of micrometers. The sprayed water mist is transported to the electric field forming units 11a and 11b along with the SO₃ mist and the dust.

In a case where the water mist is sprayed, when the SO₃ mist and the dust travel while meandering, the SO₃ mist and the dust which approach the water mist are trapped by the water mist due to the Coulomb force. The water mist is trapped by a dielectric trapping unit (demister or the like) which is provided on the downstream side of the wet electric dust collector.

The SO₃ mist or the dust which is positioned in the vicinity of the earth electrode 20 adhere to the earth electrode 20 to be trapped. The SO₃ mist or the dust which is positioned in the vicinity of the flat plate portion 25a adheres to the flat plate portion 25a to be trapped.

Therefore, the SO₃ mist and the dust are removed from the flue gas.

In a case where the cleaning spray 13 is provided, the cleaning water is intermittently sprayed from the spray nozzles toward the earth electrode 20 and the application electrode 21. The SO₃ mist and the dust that adhere to the earth electrode 20 or the flat plate portion 25a are incorporated into the cleaning water and are recovered by the chimney tray 12 or fall onto the lower portion of the wet electrostatic precipitator.

In the wet electrostatic precipitator according to the first embodiment, since the corona discharges having opposite polarities are alternately generated in the flow direction of the gas, space charge is relaxed, thereby increasing input power. Therefore, the discharge current of the corona discharges from the application electrode 21 and the earth electrode 20 is increased, and thus a trapping efficiency of the electrode can be increased without an increase in the electrode area needed for dust collection.

In a case where the amount of SO₃ mist that passes through the electric field forming unit 11 is low, such as a case where the concentration of SO₃ in the flue gas is low, the SO₃ mist or the dust can be charged and trapped by the electrode without pre-charging or spraying a dielectric mist into the gas.

In addition, in the wet electrostatic precipitator according to this embodiment, it is possible to enhance the workability of the electrode and reduce the weight of the electrode while widening a corona current region and increasing input power without the degradation in the space charge relaxation effect.

### Second Embodiment

The wet electrostatic precipitator according to the second embodiment is similar to the first embodiment. The wet electrostatic precipitator of this embodiment is particularly effective in a case where the concentration of SO₃ flowing into the device is low (for example, less than 10 ppm).

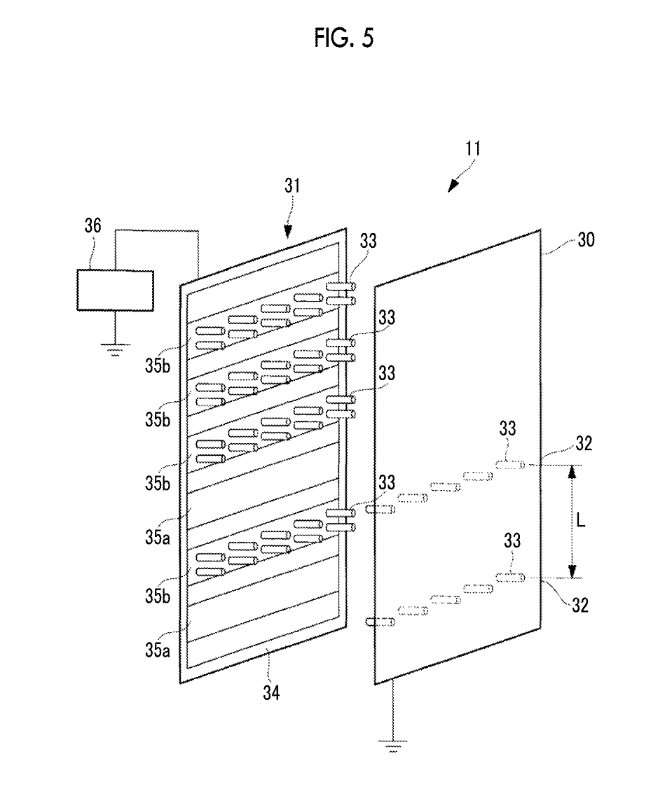

FIG. 5 is an enlarged schematic view of the electric field forming unit of the wet electrostatic precipitator according to the second embodiment. In the electric field forming unit 11, an earth electrode 30 and an application electrode 31 are arranged to oppose each other. A plurality of earth electrodes 30 and a plurality of application electrodes 31 may be alternately arranged, and the opposing surfaces of the earth electrodes 30 and the application electrodes 31 are arranged along the flow direction of the gas.

The earth electrode 30 has a flat plate shape. Discharge units 32 are provided on the surface of the earth electrode 30 that opposes the application electrode 31 on the gas upstream side (the gas inlet side of the electric field forming unit 11). In the example of FIG. 5, two discharge units 32 are formed on the gas upstream side. On the other hand, the discharge unit is not provided on the gas downstream side (the gas outlet side of the electric field forming unit 11) of the earth electrode 30. A plurality of discharge electrodes 33 are formed in the discharge unit 32 of the earth electrode 30 in the direction perpendicular to the flow direction of the gas.

A single row or a plurality of rows of discharge electrodes 33 are formed in the flow direction of the gas. The number of discharge electrodes in the gas flow direction may be appropriately set in consideration of the concentration of SO₃ in the gas flowing into the wet electric dust collector, a gas flow rate, and the like. For example, in a case where the concentration of SO₃ is low, the SO₃ mist and the dust can be sufficiently charged only by providing the single row of discharge electrodes in the gas flow direction. In a case where the plurality of discharge electrodes 33 are provided, in order to suppress the interference between the discharges of the discharge electrodes, the interval between the discharge electrodes 33 in the gas flow direction is appropriately set in consideration of the interval between the earth electrode 30 and the application electrode 31.

In the same manner as the first embodiment, the application electrode 31 is configured to include flat plate portions 35a (first flat plate portions) and flat plate portions 35b (second flat plate portions) mounted in a discharge frame 34. The flat plate portions 35a and the flat plate portions 35b are separated from each other.

On the gas upstream side, the flat plate portion 35a is disposed at a position that opposes a part of the earth electrode 30 where the discharge unit 32 is formed, and the flat plate portions 35b are arranged at predetermined intervals at positions that oppose parts of the earth electrode 30 where the discharge units 32 are not provided. The discharge units 32 of the earth electrode 30 and the flat plate portions 35b are arranged to be shifted from each other. In FIG. 5, when the interval between the discharge units 32 is referred to as L, the flat plate portions 35b are arranged to be shifted from the discharge units 32 by a phase difference of L/2.

On the gas downstream side, the flat plate portions 35b are arranged at predetermined intervals. The interval between the flat plate portions 35b on the gas downstream side is the same as or smaller than the interval between the flat plate portions 35b on the gas upstream side. In the example of FIG. 5, the interval between the flat plate portions 35b on the gas downstream side is L/2.

In the same manner as the first embodiment, a plurality of discharge electrodes 33 are formed on the surface of the flat plate portions 35b that oppose the earth electrode 30. The discharge electrode 33 provided in the application electrode 31 has a cylindrical shape in FIG. 5, and may also have a shape with a protrusion such as a cone. In the flat plate portion 35b, the plurality of discharge electrodes 33 are formed in the direction substantially perpendicular to the flow direction of the gas. A single stage or a plurality of rows (two rows in FIG. 5) of discharge electrodes 33 are formed in the flow direction of the gas. In order to suppress the interference between the discharges of the discharge electrodes, the interval between the discharge electrodes in the gas flow direction is appropriately set in consideration of the interval between the earth electrode 30 and the application electrode 31. For example, in a case where the distance between the earth electrode 30 and the application electrode 31 is 150 to 250 mm, the interval between the discharge electrodes 33 may be set to be 50 to 100 mm.

A method of removing the SO₃ and dust in the gas by using the wet electrostatic precipitator including the electric field forming unit 11 according to the second embodiment is substantially the same as that of the first embodiment. Even in the second embodiment, the SO₃ mist and the dust may be pre-charged, and the dielectric mist may be sprayed into the gas.

In the second embodiment, a positive corona discharge and a negative corona discharge are alternately generated in the vicinity of the inlet of the electric field forming unit 11, and thus space charge is relaxed. The SO₃ mist and the dust which pass through the gas upstream side of the electric field forming unit 11 are influenced by the direct current electric field while alternately changing their charge polarity, and thus travel while meandering.

Only the negative corona discharge is generated in the flow passage on the gas downstream side. The SO₃ mist and the dust are negatively charged and travel toward the earth electrode 30 in the direct current electric field. Accordingly, the SO₃ mist or the dust adheres to the earth electrode 30 to be trapped.

In a case where the cleaning spray 13 is provided, the cleaning water is intermittently sprayed from the spray nozzles toward the earth electrode 30 and the application electrode 31. The SO₃ mist and the dust that adhere to the earth electrode 30 or the flat plate portion 35a are incorporated into the cleaning water and are recovered by a gas-liquid separator such as the chimney tray 12 or fall onto the lower portion of the wet electrostatic precipitator. The electrode structure can be further simplified.

In a case where the concentration of SO₃ is low, by only alternately charging the SO₃ mist or the dust with opposite polarities on the gas upstream side as in the second embodiment, space charge can be relaxed. In addition, as illustrated in FIG. 5, providing the single row of discharge electrodes 33 of the discharge unit 32 of the earth electrode 30 in the gas flow direction is effective in relaxing space charge. Therefore, without the degradation in the space charge relaxation effect, the weight of the electrode can be reduced. In addition, the processing cost of the electrode can be reduced.

### REFERENCE SIGNS LIST

1 flue gas treatment apparatus
2 boiler
3 denitrification device
4 air heater
5 dry electrostatic precipitator
6 wet desulfurization device
7 CO₂ recovery device
8 stack
10 wet electrostatic precipitator
11, 11a, 11b electric field forming unit
12 chimney tray
13 cleaning spray
14 pre-charging unit
15 dielectric spray unit
16 nozzle
17 pump
20, 30 earth electrode (first electrode)
21, 31 application electrode (second electrode)
22, 32 discharge unit
23, 33 discharge electrode
24, 34 discharge frame
25a, 25b, 35a, 35b flat plate portion
26, 36 high-voltage power supply

1. A wet electrostatic precipitator for removing SO₃ and dust contained in gas, comprising:
an electric field forming unit which includes a first electrode and a second electrode that are arranged to oppose each other along a flow direction of the gas containing mist having the SO₃ incorporated therein and the dust so as to form a direct current electric field,
wherein the first electrode is a flat plate and includes a plurality of discharge electrodes formed on a surface of the first electrode that opposes the second electrode, along the flow direction of the gas at predetermined intervals,
the second electrode includes a discharge frame, a first flat plate portion which extends in a direction substantially perpendicular to the flow direction of the gas and is provided at a position that opposes the discharge electrode of the first electrode, and a second flat plate portion which extends in the direction substantially perpendicular to the flow direction of the gas and has a plurality of discharge electrodes formed on a surface that opposes a flat surface part of the first electrode,
the first flat plate portion and the second flat plate portion are arranged along the flow direction of the gas,
the discharge electrode of the first electrode and the discharge electrode of the second electrode alternately generate corona discharges having opposite polarities in the direction perpendicular to the flow direction of the gas so as to alternately apply charges having opposite polarities to the mist and the dust by the corona discharges when the gas passes through between the first electrode and the second electrode, and
the first electrode and the first flat plate portion trap the charged mist and the dust.

2. The wet electrostatic precipitator according to claim 1,
wherein, in the second electrode, the first flat plate portion and the second flat plate portion are alternately arranged in the flow direction of the gas.

3. The wet electrostatic precipitator according to claim 1,
wherein, on an upstream side of the gas, the discharge electrodes are formed in the first electrode, the first flat plate portion and the second flat plate portion are alternately arranged in the second electrode, the discharge electrodes of the first electrode and the discharge electrodes of the second electrode alternately generate the corona discharges having opposite polarities in the direction perpendicular to the flow direction of the gas, and
on a downstream side of the gas, the first electrode has a flat surface shape, the second flat plate portion is arranged in the second electrode, and the discharge electrodes of the second electrode generate a negative corona discharge in the direction perpendicular to the flow direction of the gas.

4. A flue gas treatment method of removing SO₃ and dust contained in gas by using the wet electrostatic precipitator according to claim 1, comprising the processes of:
forming a direct current electric field between the first electrode and the second electrode;
alternately generating the corona discharges having opposite polarities in the first electrode and the second electrode in the direct current electric field;
allowing the gas to pass through between the first electrode and the second electrode where the direct current electric field is formed and the corona discharges are generated, and alternately applying the corona discharges having opposite polarities to the mist and the dust; and
allowing the first electrode and the first flat plate portion to trap the charged mist and the dust.

5. A flue gas treatment method of removing SO₃ and dust contained in gas by using the wet electrostatic precipitator according to claim 2, comprising the processes of:
forming a direct current electric field between the first electrode and the second electrode;
alternately generating the corona discharges having opposite polarities in the first electrode and the second electrode in the direct current electric field;
allowing the gas to pass through between the first electrode and the second electrode where the direct current electric field is formed and the corona discharges are generated, and alternately applying the corona discharges having opposite polarities to the mist and the dust; and
allowing the first electrode and the first flat plate portion to trap the charged mist and the dust.

6. A flue gas treatment method of removing SO₃ and dust contained in gas by using the wet electrostatic precipitator according to claim 3, comprising the processes of:
forming a direct current electric field between the first electrode and the second electrode;
alternately generating the corona discharges having opposite polarities in the first electrode and the second electrode in the direct current electric field;
allowing the gas to pass through between the first electrode and the second electrode where the direct current electric field is formed and the corona discharges are generated, and alternately applying the corona discharges having opposite polarities to the mist and the dust; and
allowing the first electrode and the first flat plate portion to trap the charged mist and the dust.
